(19) United States
(12) Patent Application Publication
(10) Pub. No.: US 2010/0230158 A1
(43) Pub. Date: Sep. 16, 2010

(54) ACID ANHYDRIDE-INTRODUCED POLYMER, POLYMER COMPOSITION, COVERED ELECTRIC WIRE, AND WIRING HARNESS

(75) Inventors: Tatsuya Hase, Yokkaichi-shi (JP); Makoto Mizoguchi, Kasuga-shi (JP)

Correspondence Address: OLIFF & BERRIDGE, PLC, P.O. BOX 320850, ALEXANDRIA, VA, 22320-4850, US

(73) Assignees: AUTONETWORKS TECHNOLOGIES, LTD., YOKKAICHI-SHI (JP); SUMITOMO WIRING SYSTEMS, LTD., YOKKAICHI-SHI (JP); SUMITOMO ELECTRIC INDUSTRIES, LTD., OSAKA-SHI (JP); KYUSHU UNIVERSITY, FUKUOKA-SHI (JP)

(21) Appl. No.: 12/734,630

(22) PCT Filed: Nov. 14, 2008
(86) PCT No.: PCT/JP2008/070734

§ 371 Date: May 13, 2010

(30) Foreign Application Priority Data
Nov. 16, 2007 (JP) 2007-297402

(51) Int. Cl. H01B 7/00; C08L 35/00; C08L 23/14; H01B 3/30

(52) U.S. Cl. 174/72 A; 525/207; 524/582; 174/110 SR

(57) ABSTRACT

An acid anhydride-introduced polymer and a polymer composition that have improved material properties including mechanical properties when used along with fillers. In the acid anhydride-introduced polymer, a side chain is grafted onto a polymer main chain, and an acid anhydride structure is introduced into the grafted side chain through an imide bond or an amide bond. The acid anhydride-introduced polymer may be obtained by reacting an amino group-containing polymer in which an alkyl chain having an amino group at a terminal is grafted onto a polymer main chain, and a compound having two acid anhydride structures. The polymer main, chain preferably is an olefin resin or a styrene thermoplastic elastomer. The polymer composition includes the acid anhydride-introduced polymer and fillers. The acid anhydride-introduced polymer content is preferably within the range of 0.1 to 20 mass %.

### TECHNICAL FIELD

The present invention relates to an acid anhydride-introduced polymer, an interface toughening agent, a polymer composition, a covered electric wire, and a wiring harness.

### BACKGROUND ART

Conventionally, a polymer composition containing a resin, a rubber, an elastomer, and other elements is used in various technical fields. In order to impart various functions to the polymer composition, fillers are often added thereto depending on the intended use.

For example, in the field of an electric wire that is used for wiring of parts for a car such as an automobile and parts for an electrical/electronic appliance, the polymer composition is used for a covering material of the electric wire. Various fillers including a plasticizer, a stabilizer, and a flame retardant are sometimes added to the covering material depending on properties necessary for the electric wire such as mechanical properties including wear resistance, flexibility, workability, and flame retardancy.

However, the addition of the fillers to the polymer composition sometimes unintentionally degrades the material properties including mechanical properties of the polymer composition depending on the kind, quality, and added amount of the fillers.

For the electric wire, for example, an organic polymer such as an olefin resin that does not emit harmful halogenous gas during combustion is recently used for the covering material in view of reducing loads on the global environment.

In this case, in order to achieve sufficient flame retardancy, it is effective if a large amount of flame retardant is added. However, the addition of a large amount of flame retardant remarkably degrades the mechanical properties including wear resistance of the polymer composition (see Japanese Patent No. 3280099).

### DISCLOSURE OF THE INVENTION

### Problem to be Solved by the Invention

The cause of the degradation of the material properties including wear resistance is supposed to be insufficient dispersion of the fillers in the polymer composition. Although several attempts have been made to enhance dispersibility of the fillers in order to prevent the degradation of the material properties including wear resistance, the material properties including mechanical properties are susceptible to improvement.

An object of the present invention is to overcome the problems described above and to provide an acid anhydride-introduced polymer and a polymer composition that have improved material properties including mechanical properties when used along with fillers. Another object of the present invention is to provide a covered electric wire and a wiring harness including the polymer composition that have excellent mechanical properties including wear resistance.

### Means for Solving Problem

As a result of intensive studies made by the inventors, it was found that even though fillers are included, material properties including mechanical properties can be improved by using a material that combines a structure excellent in an affinity for the fillers and a structure excellent in an affinity for an organic polymer such as an olefin resin.

To achieve the objects and in accordance with the purpose of the present invention, an acid anhydride-introduced polymer is configured such that an acid anhydride structure is introduced into a molecular structure.

It is preferable that, in the acid anhydride-introduced polymer, a side chain is grafted onto a polymer main chain, and the acid anhydride structure is introduced into the grafted side chain.

It is preferable that the acid anhydride structure is introduced into the grafted side chain through an imide bond or an amide bond.

According to another preferred embodiment of the present invention, an acid anhydride-introduced polymer is obtained by reacting a functional group-containing polymer that is prepared by grafting an alkyl chain having a functional group at a terminal onto a polymer main chain and a compound having an acid anhydride structure.

It is preferable that the functional group is an amino group, and the functional group-containing polymer and the compound having the'acid anhydride structure form an imide bond or an amino bond.

In addition, it is preferable that the polymer main chain includes an olefin resin and/or a styrene thermoplastic elastomer.

A polymer composition according to the present invention includes the acid anhydride-introduced polymer and fillers.

It is preferable that the acid anhydride-introduce polymer content is within the range of 0.1 to 20 mass.

A covered electric wire according to the present invention includes the polymer composition as a covering material.

A wiring harness according to the present invention includes the polymer composition.

### EFFECT OF THE INVENTION

Because the acid anhydride-introduced polymer according to the present invention is configured such that the acid anhydride structure is introduced into the molecular structure, the acid anhydride-introduced polymer has improved material properties, especially mechanical properties, when used along with the filler. It is estimated that this effect is achieved because the acid anhydride structure in the acid anhydride-introduced polymer has an excellent affinity for the fillers, which prevents the fillers from cohering to each other and highly disperses the fillers in the polymer composition.

In addition, because the acid anhydride-introduced polymer has a polymer structure, the acid anhydride-introduced polymer itself may constitute a polymer component of the polymer composition' or may constitute the polymer component of the polymer composition along with other organic polymer. In the latter case, the polymer component is compatible with the other organic polymer, and therefore, the fillers that are bonded to the acid anhydride-introduced polymer can be highly dispersed in the polymer composition. Thus, the acid anhydride-introduced polymer has improved material properties including mechanical properties.

The acid anhydride-introduced polymer that is configured such that the side chain is grafted onto the polymer main chain and the acid anhydride structure is introduced into the grafted side chain has improved material properties including mechanical properties when used along with the fillers.

The acid anhydride structure can be introduced into the grafted side chain with reliability through the imide bond or the amide bond. Various acid anhydride structures can be easily introduced through the imide bond or the amide bond. The acid anhydride structure can be introduced more strongly through the imide bond or the amide bond.

Because the acid anhydride-introduced polymer is obtained by reacting the functional group-containing polymer that is prepared by grafting the alkyl chain having the functional group at the terminal onto the polymer main chain and the compound having the acid anhydride structure, various acid anhydride structures can be introduced and the introduction of the acid anhydride structure can be easily performed.

If the functional group is the amino group and the functional group-containing polymer and the compound having the acid anhydride structure form the imide bond or the amino bond, the effects described above are achieved with reliability.

If the polymer main chain includes the olefin resin and/or the styrene thermoplastic elastomer, a halogen element is not included, and therefore, halogenous gas is not emitted during combustion, which is friendly to the global environment.

In addition, because the polymer composition according to the present invention includes the acid anhydride-introduced polymer and the fillers, mechanical properties of a material including the polymer composition can be improved.

If the acid anhydride-introduced polymer content in the polymer composition is within the range of 0.1 to 20 mass %, the effect of improving mechanical properties of the material especially becomes excellent.

In addition, because the covered electric wire according to the present invention includes the polymer composition as the covering material and the wiring harness according to the present invention includes the polymer composition, mechanical properties including wear resistance become excellent. Accordingly, the material is prevented from degrading, and high reliability can be achieved for a long time.

### BEST MODE FOR CARRYING OUT THE INVENTION

A detailed description of preferred embodiments of the present invention will now be provided.

An acid anhydride-introduced polymer according to the present invention is configured such that an acid anhydride structure is introduced into a molecular structure of the polymer.

The acid anhydride structure has an excellent affinity for various fillers including a plasticizer, a stabilizer, and a flame retardant that are to be contained in a polymer composition used for, a covering material of a covered electric wire, and has capability of being bonded to the fillers. Thus, it is considered that when included along with the fillers in the polymer composition, the acid anhydride-introduced polymer exerts an effect of improving compatibility between the polymer and the fillers in the polymer composition. In other words, it is considered that the fillers are prevented from cohering to each other and are easily highly dispersed into the polymer composition. Accordingly, the inclusion of the acid anhydride-introduced polymer allows the polymer composition to have improved mechanical properties including wear resistance.

The position at which the acid anhydride structure is introduced into the molecular structure of the polymer is not particularly limited. For example, the acid anhydride structure may be introduced into a polymer main chain of the acid anhydride-introduced polymer or may be introduced into a side chain that is grafted onto the polymer main chain of the acid anhydride-introduced polymer. The position may be determined as appropriate in consideration of easy introduction of the acid anhydride structure and versatility such that various acid anhydride structures can be introduced.

The introduction of the acid anhydride structure may be performed by, for example, a method of reacting a functional group-containing polymer and a compound having an acid anhydride structure, or a method of reacting a functional group-containing polymer and a polycarboxylic acid and then ring-closing the polycarboxylic acid into a carboxylic anhydride by using a dehydrating agent such as an acetic anhydride.

In the introduction of the acid anhydride structure, a reaction solvent may be used, and stirring may be performed. In order to increase a reaction speed, heating may be performed, and a catalyst may be added. A by-product may be removed so as to shift equilibrium of the reaction to a product side and obtain the object with a high yield.

The functional group-containing polymer is not particularly limited. Examples of the functional group-containing polymer include a polymer in which an alkyl side chain is grafted onto a polymer main chain and a functional group is included at a terminal of the alkyl side chain. The functional group is not particularly limited. Examples of the functional group include an amino group and a hydroxyl group from the view point of being easily bonded to the compound having the acid anhydride structure.

The compound having the acid anhydride structure is capable of being bonded to the functional, group by reacting with the functional group. Examples of the compound having the acid anhydride structure in the case of the functional group being the amino group include a compound having a plurality of acid anhydride structures and a compound having a substitute active ester group and an acid anhydride structure. It is preferable that the compound having the plurality of acid anhydride structures is added more than equivalent to the amino group-containing polymer in order to leave at least one acid anhydride structure. In the case of reacting the amino group-containing polymer and the compound having the plurality of acid anhydride structures, the plurality of acid anhydride structures are introduced into the molecular structure of the polymer through an imide bond or an amide bond.

On the other hand, by reacting the amino group-containing polymer and the polycarboxylic acid, the polycarboxylic acid is introduced into the molecular structure of the polymer through the imide bond or the amide bond. By subsequently ring-closing the polycarboxylic acid into the carboxylic anhydride by using the dehydrating agent, the acid anhydride structure is introduced into the molecular structure of the polymer through the imide bond or the amide bond.

The functional group content in the functional group-containing polymer is preferably within the range of 0.1 to 10 mass %. If the content is less than 0.1 mass %, the introduced amount of the acid anhydride structure in the obtained acid anhydride-introduced polymer becomes less, which easily lowers capability of the acid anhydride-introduced polymer to be bonded to the fillers. If the content is more than 10 mass %, the introduced amount of the acid anhydride structure in the obtained acid anhydride-introduced polymer becomes excessively great, which easily lowers compatibility with a polymer matrix in the polymer composition.

In the method of introducing the compound having the acid anhydride structure by using the functional group-containing polymer as a precursor, the acid anhydride structure can be easily introduced through the functional group. By designing compounds having various acid anhydride structures, various acid anhydride structures can be introduced, which can reduce limitations of the acid anhydride structure. Because the acid anhydride structure is included not by interaction but by bonding, excellent stability is achieved.

Especially in the case of the functional group-containing polymer being the amino group-containing polymer, the acid anhydride structure can be introduced with reliability through the imide bond or the amide bond. In addition, various acid anhydride structures can be easily introduced through the imide bond or the amide bond, especially through a strong imide bond or a strong amide bond.

Examples of a method of preparing the amino group-containing polymer include a method of grafting a monomer of an unsaturated aliphatic amine onto a polymer main chain and a method of condensing a carboxylic acid-modified polymer and a diamine. The present invention is not particularly limited thereto. A functional group-containing polymer containing a functional group other than the amino group may be prepared by a similar method.

In order to prepare the amino group-containing polymer by the grafting method, the polymer and the monomer of the unsaturated aliphatic amine are preferably reacted in the presence of a radical generating agent. Examples of the radical generating agent include organic peroxide such as benzoyl peroxide, dicumyl peroxide, di-tert-butyl peroxide, butyl peracetate, and tert-butyl perbenzoate.

Examples of the polymer defining the polymer main chain include an olefin resin and a styrene thermoplastic elastomer. They may be used singly or in combination.

Examples of the olefin resin include polyolefin such as polyethylene and polypropylene, and a copolymer of alpha-olefin such as ethylene, propylene, 1-butene, 1-pentene, 1-hexene, 1-heptene, and 1-octene. They may be used singly or in combination.

Examples of a component for copolymerizing with styrene in the styrene thermoplastic elastomer include ethylene, propylene, butadiene, and isoprene. They may be copolymerized singly or in combination.

Examples of the styrene thermoplastic elastomer include a styrene-butadiene block copolymer, a styrene-ethylene-styrene copolymer (SES) and a styrene-ethylene-butylene-styrene copolymer (SEBS) that are hydrogenerated or partially-hydrogenerated derivatives of the styrene-butadiene block copolymer, a styrene-isoprene block copolymer, a styrene-ethylene-propylene copolymer (SEP), a styrene-ethylene-propylene-styrene copolymer (SEPS), and a styrene-ethylene-ethylene-propylene-styrene copolymer (SEEPS) that are hydrogenerated or partially-hydrogenerated derivatives of the styrene-isoprene block copolymer.

Examples of the unsaturated aliphatic amine include oleylamine, erucylamine, ricinoleyl amine, and linolyl amine.

Examples of the method of preparing the carboxylic acid-modified polymer include a grafting method of grafting a monomer of an unsaturated carboxylic acid onto a polymer main chain and a copolymerizing method of copolymerizing a monomer of olefin such as ethylene and propylene and styrene, and a monomer of an unsaturated carboxylic acid. However, the present invention is not limited thereto.

Examples of the grafting method of preparing the carboxylic acid-modified polymer include a method of grafting the polymer and the monomer of the unsaturated carboxylic acid in the presence of the radical generating agent. Examples of the radical generating agent may be the same as those described above, e.g., the organic peroxide.

Examples of the polymer that is modified by the carboxylic acid by the grafting method include an olefin resin and a styrene thermoplastic elastomer. They may be used singly or in combination. Examples of the olefin resin and the styrene thermoplastic elastomer may be the same as those described above.

The carboxylic acid-modified amount of the carboxylic acid-modified polymer is preferably within the range of 0.1 to 10 mass %. If the modified amount is less than 0.1 mass %, an amount of the acid anhydride structure to be introduced into the carboxylic acid-modified polymer becomes small, which easily lowers the effect of improving material properties including mechanical properties of the carboxylic acid-modified polymer when used along with the fillers. If the modified amount is more than 10 mass %, the amount of the acid anhydride structure to be introduced into the carboxylic acid-modified polymer becomes excessively great, which easily causes coherence of the fillers.

Examples of the carboxylic acid and the derivative thereof include maleic acid, maleic acid anhydride, maleic acid monoester, maleic acid diester, fumaric acid, fumaric acid anhydride, fumaric acid monoester, fumaric acid diester, phthalic acid, phthalic acid anhydride, phthalic acid monoester, and phthalic acid diester. Among them, the maleic acid anhydride and the fumaric acid anhydride are preferable because they have high reaction activity with the diamine and easily form the amino-group containing polymer. Additionally, maleic acid anhydride modified polymers are easily available.

Examples of the diamine include diamine with carbon number from 2 to 13, e.g., ethylenediamine, tetramethylenediamine, hexamethylenediamine, decamethylenediamine, and dodecamethylenediamine.

Examples of the compound having the plurality of acid anhydride structures include pyromellitic dianhydride (benzene-1,2,4,5-tetracarboxylic dianhydride), ethylenediamine tetraacetic dianhydride, diethylenetriamine pentaacetic dianhydride, 3,4,3′,4′-biphenyltetracarboxylic dianhydride, 3,4,3′,4′-benzophenone tetracarboxylic dianhydride, 2,3,3′,4′-biphenyltetracarboxylic dianhydride, 2,3,2′,3′-benzophenone tetracarboxylic dianhydride, 2,2-bis(3,4-dicarboxyphenyl)propane dianhydride, 2,2-bis(2,3-dicarboxyphenyl)propane dianhydride, bis(3,4-dicarboxyphenyl)ether dianhydride, bis(2,3-dicarboxyphenyl)ether dianhydride, 4,4′-[2,2,2-trifluoro-1-(trifluoromethyl) ethylidene]bis(benzeneclicarboxylic anhydride), 9,9-bis[4-(3,4-dicarboxyphenoxy)phenyl]fluorine dianhydride, 1,2,5,6-naphthalene tetracarboxylic dianhydride, 2,3,6,7-naphthalene tetracarboxylic dianhydride, 3,4,9,10-perylene tetracarboxylic dianhydride, 2,3,5,6-pyridine tetracarboxylic dianhydride, and bicyclo(2,2,2)-octo-7-ene-2,3,5,6-tetracarboxylic dianhydride.

Examples of the polycarboxylic acid include ethylenediamine tetraacetic acid, diethylenetriamine pentaacetic acid, mellitic acid, trimellitic acid, pyromellitic acid, ethylenediamine diacetic acid, ethylenediamine dipropionic acid, N-hydroxyethyl ethylenediamine triacetic acid, diaminocyclohexyl tetraacetic acid, glycoletherdiamine tetraacetic acid, N,N-bis(2-hydroxybenzyl)ethylenediamine diacetic acid, hexamethylenediamine N,N,N,N-tetraacetic acid, nitrilotriacetic acid, nitrilotripropionic acid, and triethylenetetramine hexacetic acid.

The method of introducing the acid anhydride structure is not limited to the method described above. Examples of the method of introducing the acid anhydride structure include a method of copolymerizing the monomer component having the acid anhydride structure and the other monomer component and a method of grafting the monomer component having the acid anhydride structure onto the polymer main chain of the polymer compound.

Examples of the monomer component having the acid anhydride structure include a monomer component in which an unsaturated carboxylic acid anhydride is bonded to one of the N terminals of a diamine and a compound having a plurality of acid anhydride structures is bonded to the other N terminal.

Other examples of the method of introducing the acid anhydride structure include a method of copolymerizing the monomer component having the functional group and the other monomer component and then reacting the compound having the acid anhydride structure through the functional group and a method of grafting the monomer component having the functional group onto the polymer main chain of the polymer compound and then reacting the compound having the acid anhydride structure through the functional group.

Examples of the monomer component having the functional group include a monomer component in which an unsaturated carboxylic acid anhydride is bonded to one of the N terminals of a diamine through an imide bond or an amide bond.

Next, descriptions of preferred embodiments of the acid anhydride-introduced polymer according to the present invention will be provided. The chemical formulae 1 to 4 provided below show the embodiments of the acid anhydride-introduced polymer in which an alkyl chain is grafted onto a polymer main chain, and an acid anhydride structure is introduced into the grafted side chain through an imide bond. In the chemical formulae 1 to 4, the polymer main chain is represented by R1, and the grafted side chain having the acid anhydride structure is shown in the center. R1 represents any one of polyethylene, polypropylene, and SEBS. It should be noted that the acid anhydride-introduced polymer according to the present invention is not limited to the compounds described below.

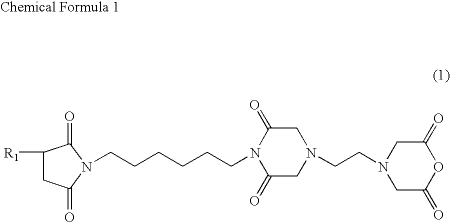

The chemical formula 1 shows an acid anhydride-introduced polymer in which an acid anhydride structure of ethylenediamine tetraacetic acid dianhydride origin is introduced into a grafted side chain through an imide bond. The acid anhydride structure at a terminal allows the polymer to be bonded to the filler surface. The acid anhydride-introduced polymer of the chemical formula 1 is obtained by reacting a maleic acid anhydride-modified polymer and hexamethylenediamine so as to form an amino group-containing monomer having an amino group at a terminal and then reacting the amino group-containing monomer and ethylenediamine tetraacetic dianhydride.

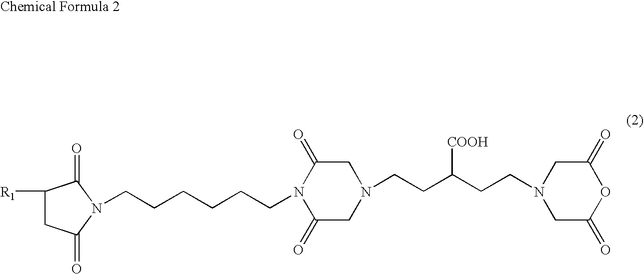

The chemical formula 2 shows an acid anhydride-introduced polymer in which an acid anhydride structure of diethylenetriamine pentaacetic acid dianhydride origin is introduced into a grafted side chain through an imide bond. The acid anhydride structure at a terminal allows the polymer to be bonded to the filler surface. The acid anhydride-introduced polymer of the chemical formula 2 is obtained by reacting a maleic acid anhydride-modified polymer and hexamethylenediamine so as to form an amino group-containing monomer having an amino group at a terminal and then reacting the amino group-containing monomer and diethylenetriamine pentaacetic dianhydride.

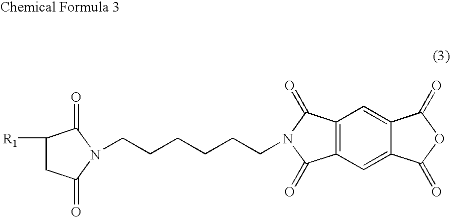

The chemical formula 3 shows an acid anhydride-introduced polymer in which an acid anhydride structure of pyromellitic dianhydride origin is introduced into a grafted side chain through an imide bond. The acid anhydride structure at a terminal allows the polymer to be bonded to the filler surface. The acid anhydride-introduced polymer of the chemical formula 3 is obtained by reacting a maleic acid anhydride-modified polymer and hexamethylenediamine so as to form an amino group-containing monomer having an amino group at a terminal and then reacting the amino group-containing monomer and pyromellitic dianhydride.

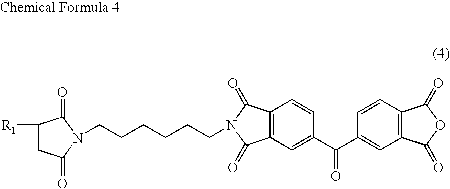

The chemical formula 4 shows an acid anhydride-introduced polymer in which an acid anhydride structure of 3,3′,4,4′-benzophenone tetracarboxylic dianhydride origin is introduced into a grafted side chain through an imide bond. The acid anhydride structure at a terminal allows the polymer to be bonded to the filler surface. The acid anhydride-introduced polymer of the chemical formula 4 is obtained by reacting a maleic acid anhydride-modified polymer and hexamethylenediamine so as to form an amino group-containing monomer having an amino group at a terminal and then reacting the amino group-containing monomer and 3,3′,4,4′-benzophenone tetracarboxylic dianhydride.

Next, a description of a polymer composition according to the present invention will be provided. The polymer composition according to the present invention includes the acid anhydride-introduced polymer described above and fillers. Because the acid anhydride-introduced polymer has a polymer structure, the acid anhydride-introduced polymer itself may constitute a polymer component of the polymer composition or may constitute the polymer component of the polymer composition along with other organic polymer. The other organic polymer is not particularly limited. Examples of the other organic polymer include a resin, an elastomer, and a rubber. They may be used singly or in combination.

If the acid anhydride-introduced polymer is used along with the other organic polymer, the acid anhydride structure in the acid anhydride-introduced polymer is bonded to the fillers, and the polymer main chain in the acid anhydride-introduced polymer blends well with the other organic polymer. Thus, the acid anhydride-introduced polymer toughens the interface between the other organic polymer and the fillers. In other words, the acid anhydride-introduced polymer makes the other organic polymer and the fillers become easily mixed. In this regard, the acid anhydride-introduced polymer acts as an interface toughening agent.

In the polymer composition according to the present invention, the acid anhydride-introduced polymer content is preferably within the range of 0.1 to 20 mass %, more preferably within the range of 0.5 to 10 mass %. If the content is less than 0.1 mass %, the low content easily lowers the effect of improving material properties including mechanical properties of the polymer composition. If the content is more than 20 mass %, the cost is increased. The content of the acid anhydride-introduced polymer in the range described above makes the effect of improving material properties including mechanical properties of the polymer composition more excellent.

Examples of the resin as the other organic polymer include an olefin resin such as polypropylene (PP), polyethylene (PE), ethylene-methyl acrylate (EMA), ethylene-ethyl acrylate (EEA), ethylene-butyl acrylate (EBA), ethylene-methyl methacrylate (EMMA), and ethylene-vinyl acetate (EVA), a polyester resin such as a polyamide resin (PA), polyethylene terephthalate (PET), and polybutylene terephthalate (PBT), and an engineering plastic such as a polysulfone resin, a polyarylate resin, a polyphenylene sulfide resin, a thermoplastic polyurethane resin, and polycarbonate (PC).

Examples of the elastomer as the other organic polymer include an olefin elastomer (e.g., TPO), a styrene elastomer (e.g., SEES), an amide elastomer, an ester elastomer, a urethane elastomer, an ionomer, a fluoro elastomer, and a thermoplastic elastomer such as 1,2-polybutadiene and trans-1,4-polyisoprene.

Examples of the rubber as the other organic polymer include an ethylene propylene rubber (EPR), a butadiene rubber (BR), and an isoprene rubber (IR).

In order to improve physicalities, a functional group may be introduced into the resin, the elastomer, or the rubber as appropriate in such a range that the physicalities are not impaired. Examples of the functional group introduced include a carboxylic acid group, an acid anhydrous group, an epoxy group, a hydroxyl group, an amino group, an alkenyl cyclic imino ether group, and a silane group. They may be used singly or in combination.

The fillers are added depending on necessary properties of the material. The added amount of the fillers is determined depending on the kind of the fillers and necessary properties of the material. The added amount of the fillers is preferably 30 to 250 parts by mass, more preferably 50 to 200 parts by mass with respect to 100 parts by mass of the polymer component in the polymer composition. If the added amount is less than 30 parts by mass, the effect of adding the fillers is small. If the added amount is more than 250 parts by mass, properties of the polymer are easily cancelled by the fillers.

The fillers are not particularly limited. Examples of the fillers include metal powder, carbon black, graphite, carbon fiber, silica, alumina, titanium oxide, iron oxide, zinc oxide, magnesium oxide, tin oxide, antimony oxide, barium ferrite, strontium ferrite, aluminum hydroxide, magnesium hydroxide, calcium sulfate, magnesium sulfate, barium sulfate, talc, clay, mica, calcium silicate, calcium carbonate, magnesium carbonate, glass fiber, calcium titanate, lead zirconate titanate, aluminum nitride, silicon carbide, wood fiber, fullerene, carbon nanotube and melamine cyanurate. They may be used singly or in combination.

According to the present invention, additives that are generally used in a polymer composition may be included, in addition to the organic polymer and the fillers, in such a range that characteristics of the present invention are not impaired. Examples of the additives include an antioxidant, a metal deactivator (a copper inhibitor), an ultraviolet absorber, an ultraviolet-concealing agent, a flame retardant, a flame-retardant auxiliary agent, a processing aid (e.g., a lubricant and wax), and a coloring pigment.

In addition, the polymer composition according to the present invention may be cross-linked as necessary. Examples of the cross-linking include peroxide cross-linking, silane cross-linking, and radiation cross-linking. However, the present invention is not limited thereto.

The method of producing the polymer composition according to the present invention is not particularly limited, and known production methods may be used. For example, the polymer composition may be obtained by mixing the acid anhydride-introduced polymer, the fillers, the other organic polymer as necessary, and the other additives and dry blending them with the use of a generally used tumbler, or melting and kneading them with the use of a generally used kneader such as a Banbury mixer, a pressure kneader, a kneading extruder, a twin-screw extruder, and a roll so as to uniformly disperse them.

The method of blending the components constituting the composition is not particularly limited. Examples of the method of blending the components include a method of mixing and kneading the acid anhydride-introduced polymer and the fillers and then adding the other organic polymer and the additives thereto and kneading them, and a method of mixing and kneading all of the components constituting the composition.

The temperature during the kneading is preferably such a temperature that viscosity of the organic polymer is lowered to such an extent that the fillers are easily dispersed in the polymer composition. To be specific, the temperature is preferably within the range of 100 to 300° C. If heat is generated by the organic polymer by being subjected to shear during the kneading, the temperature is controlled to be an optimum temperature in consideration of a temperature rise by the heat generation.

After the kneading, the polymer composition is removed out of the kneader. The polymer composition may be molded into a pellet with the use of a pelletizer.

The application of the polymer composition according to the present invention is not particularly limited. Examples of the application of the polymer composition include application to a covering material of a covered electric wire that is used as wiring of parts for a car such as an automobile and parts for an electrical/electronic appliance, or a material to which fillers are added such as a wiring harness protective material that covers an electric wire bundle, connector parts such as a connector housing, a medical appliance, an artificial organ, a polymer paint, and a building materiel.

Next, descriptions of a covered electric wire and a wiring harness according to the present invention will be provided.

The covered electric wire according to the present invention is an electric wire in which the polymer composition described above is used as a covering material. The covered electric wire may be configured such that the covering material directly covers a conductor, or such that an intermediate material such as an insulator and a shield is sandwiched between the conductor and the covering material. The covering material may consist of a plurality of layers.

The diameter, material, and other factors of the conductor are not particularly limited and may be chosen as appropriate depending on the intended use. In addition, the thickness of the covering material is not particularly limited and may be determined as appropriate in consideration of the conductor diameter.

The covered electric wire is prepared by extrusion-covering, with the use of a generally used extrusion molding machine, the conductor with the polymer composition according to the present invention that has been kneaded with the use of a generally used kneader such as a Banbury mixer, a pressure kneader, and a roll. Alternatively, the covered electric wire may be prepared by extrusion-covering the conductor with the polymer composition according to the present invention while kneading the polymer composition with the use of a single-screw extruder or a twin-screw extruder.

The wiring harness according to the present invention includes the polymer composition described above. The wiring harness according to the present invention may be a wiring harness that includes the covered electric wire according to the present invention in which the polymer composition described above is used as the covering material, or may be a wiring harness in which the polymer composition described above is used as a wiring harness protective material that covers an electric wire bundle including a plurality of covered electric wires. The electric wire bundle in the case of using the polymer composition as the wiring harness protective material may or may not include the covered electric wire according to the present invention. The number of electric wires may be arbitrarily determined and is not particularly limited.

The wiring harness protective material covers the electric wire bundle including the plurality of covered electric wires in order to protect the electric wire bundle against the external environment. The base material of the wiring harness protective material is not particularly limited and is preferably an olefin-based polymer composition such as polyethylene and polypropylene.

Examples of the wiring harness protective material include a material in which an adhesive is applied to at least one of the surfaces of a base material having a tape shape and a material that has a base material having a tube shape or a sheet shape.

### Example

A more specific description of the present invention will now be provided with reference to examples. However, the present invention is not limited hereto. It should be noted that wear resistance of a covered electric wire that is one of material properties was evaluated in Example.

(Material Used, Manufacturer, and Other Information)

Materials used in examples and comparative examples are provided below along with their manufacturers, trade names, and other information.

(A) Organic Polymer

Polypropylene (PP) [manuf.: Prime Polymer Co., Ltd., trade name: PRIME POLYPRO E-150GK]

Polyethylene (PE) [manuf.: Prime Polymer Co., Ltd., trade name: HI-ZEX 5000S]

Ethylene-vinyl acetate copolymer (EVA) [manuf.: Du Pont-Mitsui Polychemicals Co., Ltd., trade name: EVAFLEX EV360]

Ionomer [manuf.: Du Pont-Mitsui Polychemicals Co., Ltd., trade name: HIMILAN 1706]

Olefin thermoplastic elastomer (TPO) [manuf.: Prime Polymer Co., Ltd., trade name: T310E]

Modified styrene thermoplastic elastomer (modified SEBS) [manuf.: Kraton Polymers LLC, trade name: KRATON G FG1901X]

Polyamide (PA6) [manuf.: Du Pont Kabushiki Kaisha, trade name: ZYTEL FN727]

Polycarbonate (PC) [manuf.: Mitsubishi Engineering-Plastics Corporation, trade name: IUPILON S-2000]

Polybutylene terephthalate (PBT) [manuf.: Toray Industries., Inc., trade name: TORAYCON 1401X06]

Ethylene-propylene rubber (EPR) [manuf.: JSR corporation, trade name: EP51]

Butadiene rubber (BR) [manuf.: JSR corporation, trade name: BR01]

Isoprene rubber (IR) [manuf.: JSR corporation, trade name: IR2200]

(B) Filler

Inorganic metal hydride (magnesium hydroxide) [manuf.: Martinswerk GmbH, trade name: MAGNIFIN H10]

Melamine cyanurate [manuf.: DSM Japan K.K., trade name: MELAPUR MC15]

Clay [manuf.: SHIRAISHI CALCIUM KAISHA, LTD., trade name: OPTIWHITE]

Calcium carbonate [manuf.: SHIRAISHI CALCIUM KAISHA, LTD., trade name: HAKUENKA CCR]

Talc [manuf.: Nippon Talc Co, Ltd., trade name: MS-P]

Zinc oxide [manuf.: HakusuiTech Co., Ltd., trade name: ZINC DUST #2]

(C) Other Additive

Antioxidant [manuf.: Ciba Specialty Chemicals Inc., trade name: IRGANOX 1010]

Metal deactivator [manuf.: Ciba Specialty Chemicals Inc., trade name: IRGANOX MD1024]

(D) Acid Anhydride-Introduced Polymer

Synthesis of a Compound A (the Compound Represented by the Formula 1)

Two hundred grams maleic anhydride-modified polypropylene (manuf: SANYOKASEI CO., LTD., trade name: UMEX 1010) was suspended in 1.5 liters xylene, and the liquid was heated to 130° C. so as to dissolve the maleic anhydride-modified polypropylene. Then, 70 grams hexamethylenediamine was added thereto, and the liquid was stirred for two hours while keeping it at 130° C. After the reaction, the liquid was cooled to room temperature, and the cooled liquid was added to 3 liters cold methanol while being stirred, and then the liquid was subjected to reprecipitation. The liquid was stirred for one hour at room temperature and was then subjected to vacuum filtration to separate a precipitated polymer compound. The filtrated solid was put into 3 liters cold methanol, the liquid was stirred for one hour for suspension, and unreacted hexamethylenediamine was removed therefrom. Then, the liquid was subjected to vacuum filtration again and the filtrated solid was dried for 24 hours in a vacuum. As a result, 198 grams aminohexane-modified polypropylene was obtained.

Then, 30 grams aminohexane-modified polypropylene and 5 grams ethylenediamine tetraacetic dianhydride were put into 400 milliliters xylene so as to be suspended. Then, the liquid was heated to 120° C. while being stirred and reacted for two hours. A light yellow transparent liquid thus obtained was gradually put into 2 liters cold methanol while being vigorously stirred, and the liquid was subjected to reprecipitation. After stirring the liquid for one hour at room temperature, the liquid was subjected to vacuum filtration so as to separate a precipitated polymer compound. The precipitated polymer compound was dried for 24 hours in a vacuum so as to obtain an object material (IR: 1860 cm⁻¹, 1780 cm⁻¹, 1700 cm⁻¹).

Synthesis of a Compound B (the Compound Represented by the Formula 2)

A compound B was synthesized in a similar procedure to the compound A except for using diethylenetriamine pentaacetic dianhydride in stead of ethylenediamine tetraacetic dianhydride (IR: 1860 cm⁻¹, 1780 cm⁻¹, 1700 cm⁻¹, 1640 cm⁻¹, 1305 cm⁻¹).

(Preparation of Polymer Composition and Covered Electric Wire)

First, components shown in Table 1 and 2 provided below were put into a double-shaft kneader and were kneaded for about five minutes at a favorable temperature at which an organic polymer and a chelate-introduced polymer flow (e.g., 220° C. for polypropylene), and the kneaded compound was molded into a pellet. Thus, polymer compositions according to the examples and polymer compositions according to the comparative examples were obtained. Then, each of the obtained compositions was subjected to extrusion covering at a thickness of 0.20 mm with the use of a 50 mm diameter extruder so as to extrusion cover a conductor of an annealed copper strand (Cross Section: 0.5 mm²) that was prepared by bunching seven annealed copper wires. Thus, covered electric wires according to the examples and covered electric wires according to the comparative examples were obtained.

A wear resistance test was performed on each of the covered electric wires that were obtained as described above. Table 1 shows results of the wear resistance test on the examples, and Table 2 shows results of the wear resistance test on the comparative examples. The polymer compositions according to the comparative examples have the same kinds and contents of (A) organic polymers, (B) fillers, and (C) other additives as the polymer compositions according to the examples of corresponding numbers, while the polymer compositions according to the comparative examples are different from the polymer compositions according to the examples of corresponding numbers in that (D) acid anhydride-introduced polymers are not included. It should be noted in Tables 1 and 2 that the contents of (A) the organic polymers, (B) the fillers, and (C) the other additives are expressed in part by mass, and the contents of (D) the acid anhydride-introduced polymers are expressed in mass % with respect to the total contents of the polymer compositions.

(Wear Resistance Test)

The wear resistance test was performed by a blade-reciprocating method in accordance with JASO D611-94. To be more specific, the covered electric wires according to the examples and the covered electric wires according to the comparative examples were cut into test specimens 750 mm long, and then at a room temperature of 25° C., a blade was made to reciprocate in the long axis direction over a length of 10 mm on a surface of the covering material of each test specimen which was fixed to a table, and the number of reciprocation before the blade touches the conductor due to the wearing away of the covering material was counted. At this time, a load imposed on the blade was 7 N, and the blade was reciprocated at a speed of 50 times/minute. Then, the test specimen was moved by 100 mm and was rotated 90 degrees clockwise, and the measurement as described above was repeated. The measurement was performed three times in total with respect to one test specimen, and the smallest value was used as an evaluation value. The one whose smallest reciprocation number was 500 or more was regarded as passed.

TABLE 1

| | Example | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| (A) Organic polymer | | | | | | | | | | | | | |
| Polypropylene (PP) | 100 | | | 70 | 50 | | | | | 50 | | 50 | 100 |
| Polyethylene (PE) | | 100 | 50 | | | | | | | | 50 | | |
| Ethylene-vinyl acetate copolymer (EVA) | | | 50 | | | | | | | | | | |
| Ionomer | | | | 30 | | | | | | | | | |
| Olefin thermoplastic elastomer (TPO) | | | | | | 100 | | | | | | | |
| Styrene thermoplastic elastomer (SEBS) | | | | | 50 | | | | | | | | |
| Polyamide (PA6) | | | | | | | 100 | | | | | | |
| Polycarbonate (PC) | | | | | | | | 100 | | | | | |
| Polybutylene terephthalate (PBT) | | | | | | | | | 100 | | | | |
| Ethylene-propylene rubber (EPR) | | | | | | | | | | 50 | | | |
| Butadiene rubber (BR) | | | | | | | | | | | 50 | | |
| Isoprene rubber (IR) | | | | | | | | | | | | 50 | |
| (B) Fillter | | | | | | | | | | | | | |
| Inorganic metal hydride | 150 | | 70 | | 150 | 60 | | | | 60 | 80 | 60 | 150 |
| Melamine cyanurate | | | | | | | | | 20 | | | | |
| Clay | | 100 | | | | | | 60 | | | 20 | | |
| Calcium carbonate | | | | 50 | | 30 | | | 50 | | | | |
| Talc | | | | | | | 100 | | | | | 20 | |
| Zinc oxide | | | | | | | | | | 10 | | | |
| (C) Other additive | | | | | | | | | | | | | |
| Antioxidant | 0.2 | 0.2 | 0.2 | 0.2 | 0.2 | 0.2 | 0.2 | 0.2 | 0.2 | 0.2 | 0.2 | 0.2 | 0.2 |
| Metal deactivator | 0.1 | 0.1 | 0.1 | 0.1 | 0.1 | 0.1 | 0.1 | 0.1 | 0.1 | 0.1 | 0.1 | 0.1 | 0.1 |
| (D) Acid anhydride-introduced polymer | | | | | | | | | | | | | |
| Compound A | 10 | | 10 | 5 | 15 | | | | 10 | | 5 | 20 | 0.5 |
| Compound B | | 10 | | | | 10 | 5 | 20 | | 15 | | | |
| Wear resistance of | 830 | 720 | 580 | 760 | 730 | 590 | 920 | 730 | 860 | 820 | 620 | 760 | 530 |
| insulated electric wire (Number of times) | | | | | | | | | | | | | |

TABLE 2

| | Comparative Examples | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| (A) Organic polymer | | | | | | | | | | | | |
| Polypropylene (PP) | 100 | | | 70 | 50 | | | | | 50 | | 50 |
| Polyethylene (PE) | | 100 | 50 | | | | | | | | 50 | |
| Ethylene-vinyl acetate copolymer (EVA) | | | 50 | | | | | | | | | |
| Ionomer | | | | 30 | | | | | | | | |
| Olefin thermoplastic elastomer (TPO) | | | | | | 100 | | | | | | |
| Styrene thermoplastic elastomer (SEBS) | | | | | 50 | | | | | | | |
| Polyamide (PA6) | | | | | | | 100 | | | | | |
| Polycarbonate (PC) | | | | | | | | 100 | | | | |
| Polybutylene terephthalate (PBT) | | | | | | | | | 100 | | | |
| Ethylene-propylene rubber (EPR) | | | | | | | | | | 50 | | |
| Butadiene rubber (BR) | | | | | | | | | | | 50 | |
| Isoprene rubber (IR) | | | | | | | | | | | | 50 |
| (B) Filler | | | | | | | | | | | | |
| Inorganic metal hydride | 150 | | 70 | | 150 | 60 | | | | 60 | 80 | 60 |
| Melamine cyanurate | | | | | | | | | 20 | | | |
| Clay | | 100 | | | | | | 60 | | | 20 | |
| Calcium carbonate | | | | 50 | | 30 | | | 50 | | | |
| Talc | | | | | | | 100 | | | | | 20 |
| Zinc oxide | | | | | | | | | | 10 | | |
| (C) Other additive | | | | | | | | | | | | |
| Antioxidant | 0.2 | 0.2 | 0.2 | 0.2 | 0.2 | 0.2 | 0.2 | 0.2 | 0.2 | 0.2 | 0.2 | 0.2 |
| Metal deactivator | 0.1 | 0.1 | 0.1 | 0.1 | 0.1 | 0.1 | 0.1 | 0.1 | 0.1 | 0.1 | 0.1 | 0.1 |
| Wear resistance of | 370 | 480 | 380 | 420 | 460 | 340 | 490 | 480 | 400 | 480 | 410 | 430 |
| insulated electric wire (Number of times) | | | | | | | | | | | | |

Tables 1 and 2 show that the covered electric wires according to the comparative examples that do not include the acid anhydride-introduced polymer according to the present invention are inferior in wear resistance and that the covered electric wires according to the examples that include the acid anhydride-introduced polymer according to the present invention are excellent in wear resistance. It is estimated that these results were obtained because the acid anhydride structure in the acid anhydride-introduced polymer was strongly bonded to the fillers so as to prevent the fillers from cohering to each other and highly disperse the fillers in the polymer composition, and because the acid anhydride-introduced polymer that combines the acid anhydride structure and the polymer structure toughened the interface between the fillers and the organic polymer so as to improve bonding performance.

Accordingly, if a wiring harness including the covered electric wire according to anyone of the examples in the electric wire bundle is used in such a state that it is brought into contact with other covered electric wires in the electric wire bundle, high reliability is achieved for a long time because the covering material of the covered electric wire is not significantly worn.

In Example, wear resistance that is easily lowered by the addition of the fillers was evaluated among electric wire properties. However, the present invention is considered to have an effect of improving other electric wire properties that are lowered due to dispersibility of the fillers. In addition, the present invention is considered to have an effect of improving material properties including mechanical properties that are lowered due to dispersibility of the fillers in not only the electric wire but also other materials including molding materials in general.

The foregoing descriptions of the preferred embodiments of the invention are not intended to be exhaustive or to limit the invention to the precise form disclosed, and modifications and variations are possible in the light of the above teachings or may be acquired from practice of the invention.

1. An acid anhydride-introduced polymer, wherein:
a side chain is grafted onto a polymer main chain; and
an acid anhydride structure is introduced into the grafted side chain.

2. (canceled)

3. The acid anhydride-introduced polymer according to claim 1, wherein the acid anhydride structure is introduced into the grafted side chain through one of an imide bond and an amide bond.

4. An acid anhydride-introduced polymer obtained by reacting a functional group-containing polymer in which an alkyl chain having a functional group at a terminal is grafted onto a polymer main chain, and a compound having an acid anhydride structure.

5. The acid anhydride-introduced polymer according to claim 4, wherein:
the functional group comprises an amino group; and
the functional group-containing polymer and the compound having the acid anhydride structure form one of an imide bond and an amino bond.

6. The acid anhydride-introduced polymer according to claim 1, wherein the polymer main chain is at least one of an olefin resin and a styrene thermoplastic elastomer.

7. A polymer composition comprising:
the acid anhydride-introduced polymer according to claim 1; and a filler.

8. The polymer composition according to claim 7, wherein the acid anhydride-introduce polymer content is within a range of 0.1 to 20 mass %.

9. A covered electric wire comprising the polymer composition according to claim 7 as a covering material.

10. A wiring harness comprising the polymer composition according to claim 7.
